(19) United States
(12) Patent Application Publication
(10) Pub. No.: US 2026/0152203 A1
(43) Pub. Date: Jun. 4, 2026

(54) METHOD FOR CONTROLLING AI MESSAGE GENERATION IN VEHICLES AND DEVICE THEREOF

(71) Applicant: HYUNDAI AUTOEVER CORP., Seoul (KR)

(72) Inventor: Jong Gon KIM, Seoul (KR)

(21) Appl. No.: 19/335,168

(22) Filed: Sep. 22, 2025

(30) Foreign Application Priority Data
Dec. 4, 2024 (KR) 10-2024-0178386

(51) Int. Cl. B60W 50/14; B60W 40/08

(52) U.S. Cl. CPC B60W 50/14; B60W 40/08; B60W 2040/089; B60W 2050/146; B60W 2520/10; B60W 2540/049; B60W 2540/21; B60W 2540/22; B60W 2555/20; B60W 2556/10

(57) ABSTRACT

Methods and devices for controlling generation of an AI message in a vehicle are described. According to one embodiment, a method comprises determining generation of an AI message related to a vehicle during a driving process of the vehicle, determining a cognitive load level of a driver of the vehicle by using information related to the vehicle, determining a generation manner of the AI message based on the cognitive load level of the driver, and generating the AI message in accordance with the generation manner of the AI message, wherein the generation manner of the AI message decreases a length of the AI message as the cognitive load level of the driver increases.

### CROSS-REFERENCE TO RELATED APPLICATION

This application claims priority from Korean Patent Application No. 10-2024-0178386 filed on Dec. 4, 2024 in the Korean Intellectual Property Office and all the benefits accruing therefrom under 35 U.S.C. 119, the contents of which in its entirety are herein incorporated by reference.

### BACKGROUND

### Technical Field

The present disclosure relates to a method for controlling AI message generation in a vehicle and a device thereof, and more particularly, to a method for controlling AI message generation in accordance with a driver's cognitive load level of a vehicle and a device thereof.

### Description of the Related Art

An AI system mounted in a vehicle may analyze information that may arise during driving in real time, and may provide information to a driver in the form of voice or text on a display based on the analyzed information. Furthermore, the AI system mounted in the vehicle may provide the driver with information needed by the driver through interaction with the driver.

When the driver of the vehicle is concentrating on driving or engaging in other driving-related activities, the driver may not be able to recognize the information provided by the AI system mounted in the vehicle via voice or text. As in the example described above, when the amount of information to be processed exceeds the amount that can be processed, cognitive load may occur.

As the degree of the driver's cognitive load increases, the driver is more likely to fail to recognize information (e.g., route guidance, vehicle status, traffic information, and entertainment information) intended to be provided by the AI system mounted in the vehicle. Therefore, there is a need for technology that controls a generation manner of messages delivered to the driver by the AI system mounted in the vehicle in consideration of the degree of the driver's cognitive load.

### SUMMARY

An object of the present disclosure is to provide a method for measuring a driver's cognitive load level of a vehicle by using vehicle-related information and a device thereof.

Another object of the present disclosure is to provide a method for controlling generation and delivery of AI message delivered to a driver of a vehicle depending on the driver's cognitive load level of the vehicle and a device thereof.

Other object of the present disclosure is to provide a method for generating AI message that can be recognized by a driver of a vehicle and a device thereof.

The objects of the present disclosure are not limited to those mentioned above and additional objects of the present disclosure, which are not mentioned herein, will be clearly understood by those skilled in the art from the following description of the present disclosure.

According to an aspect of the present disclosure, there is provided a method for controlling ai message generation in vehicles. The method may comprise: determining generation of an AI message related to the vehicle during a driving process of the vehicle; determining a driver's cognitive load level of the vehicle by using information related to the vehicle; determining a generation manner of the AI message in consideration of the determined cognitive load level; and generating the AI message in accordance with the AI message generation manner, wherein the AI message generation manner decreases a length of the AI message as the cognitive load level increases.

In some embodiments, a model of the AI may be a generative AI model, and the generating the AI message may include: generating a first prompt for generating the AI message considering the AI message generation manner; transmitting the first prompt to the generative AI model; and receiving a message from the generative AI model in response to the transmission of the first prompt.

In some embodiments, the determining the AI message generation manner may include: adjusting the cognitive load level by using the amount of conversation between passengers of the vehicle; and determining the AI message generation manner in consideration of the adjusted cognitive load level.

In some embodiments, determining the AI message generation manner may include determining a preset AI message generation manner without considering the cognitive load level when the determined cognitive load level is less than a threshold value.

In some embodiments, the preset AI message generation manner may be an AI message generation manner set by the driver of the vehicle.

In some embodiments, determining a driver's cognitive load level of the vehicle may include determining the cognitive load level by using a speed of the vehicle.

In some embodiments, determining a driver's cognitive load level of the vehicle may include determining the cognitive load level by using information related to a weather condition for a location of the vehicle.

In some embodiments, information related to a weather condition for a location of the vehicle may include information on the driver's visible distance of the vehicle, which is changed depending on the weather condition for a location of the vehicle.

In some embodiments, determining a driver's cognitive load level of the vehicle may include determining the cognitive load level by using information related to the driver of the vehicle.

In some embodiments, the information related to the driver of the vehicle may include at least one of information on the driver's driving experience of the vehicle, information on the driver's accident history of the vehicle, or information on the driver's current driving time of the vehicle.

In some embodiments, determining a driver's cognitive load level of the vehicle may include determining the cognitive load level by using the number of passengers of the vehicle.

In some embodiments, determining the AI message generation manner may include determining the number of sentences constituting the AI message depending on the cognitive load level.

In some embodiments, determining the AI message generation manner may include determining a length of a sentence constituting the AI message depending on the cognitive load level.

In some embodiments, the method may further comprise outputting the generated AI message as a voice but determining a size of the output voice depending on the cognitive load level.

In some embodiments, the method may further comprise outputting the generated AI message as a voice but determining an output speed of the output voice depending on the cognitive load level.

In some embodiments, the method may further comprise displaying the generated AI message as a text but determining a size of the displayed text depending on the cognitive load level.

In some embodiments, the method may further comprise receiving the driver's response of the vehicle to the generated AI message for a preset time, wherein the preset time may be a time determined depending on the cognitive load level.

According to the aforementioned and other embodiments of the present disclosure, there is provided a method for controlling ai message generation in vehicles. The method may comprise: determining a driver's cognitive load level of the vehicle by using information related to the vehicle; determining an AI response waiting time to the driver's message of the vehicle in consideration of the determined cognitive load level; acquiring the driver's message of the vehicle for the response waiting time; and generating an AI response to the driver's message of the vehicle after the response waiting time, wherein the response waiting time is a time determined to increase as the cognitive load level increases.

According to the aforementioned and other embodiments of the present disclosure, there is provided an apparatus for controlling ai message generation in vehicles. The apparatus may comprise: a communication interface; a memory in which a computer program is loaded; and one or more processors in which the computer program is executed, wherein the computer program may include instructions to perform: an operation of determining generation of an AI message related to the vehicle during a driving process of the vehicle; an operation of determining a driver's cognitive load level of the vehicle by using information related to the vehicle; an operation of determining a generation manner of the AI message in consideration of the determined cognitive load level; and an operation of generating the AI message in accordance with the AI message generation manner, wherein the AI message generation manner decreases a length of the AI message as the cognitive load level increases.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a schematic view illustrating the overall configuration of an AI message generation control system in a vehicle according to one embodiment of the present disclosure;

FIG. 2 is a flow chart illustrating an AI message generation control method in a vehicle according to one embodiment of the present disclosure;

FIGS. 3 to 7 are detailed exemplary views illustrating the method described with reference to FIG. 2;

FIG. 8 is a detailed flow chart illustrating some operations of the method described with reference to FIG. 2;

FIG. 9 is a detailed exemplary view illustrating the method described with reference to FIG. 8;

FIG. 10 is a detailed flowchart illustrating some operations of the method described with reference to FIG. 2;

FIGS. 11 to 14 are detailed exemplary views illustrating the method described with reference to FIG. 10;

FIG. 15 is a detailed flow chart illustrating some operations of the method described with reference to FIG. 2;

FIGS. 16 and 17 are detailed exemplary views illustrating the method described with reference to FIG. 15;

FIGS. 18 and 19 are exemplary screens that may be displayed in accordance with the execution of some embodiments;

FIG. 20 is a flow chart illustrating operations that may be performed subsequently to the AI message generation control method in a vehicle, which is described with reference to FIG. 2;

FIGS. 21 and 22 are detailed exemplary views illustrating the method described with reference to FIG. 20;

FIG. 23 is a flow chart illustrating an AI message generation control method in a vehicle according to another embodiment of the present disclosure;

FIGS. 24 to 27 are detailed exemplary diagrams illustrating the method described with reference to FIG. 23; and

FIG. 28 is a block diagram illustrating a hardware configuration of a computing device used in some embodiment of the present disclosure.

### DETAILED DESCRIPTION OF THE DISCLOSURE

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, embodiments of the present disclosure will be described with reference to the attached drawings.

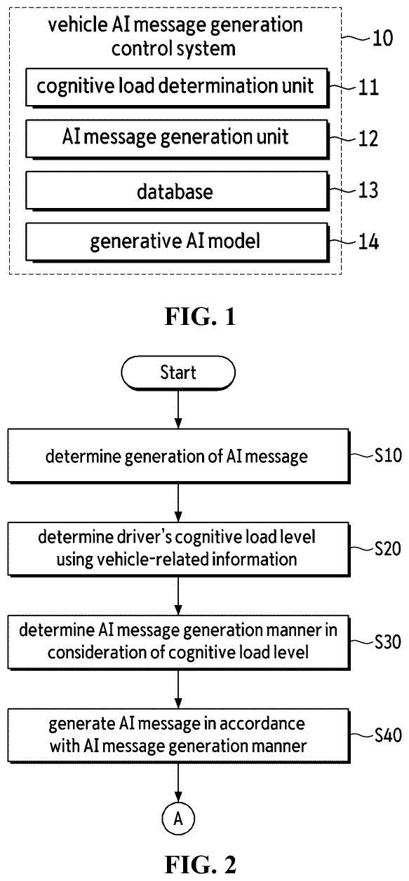

A configuration and operation of a system for controlling generation of an AI message in a vehicle according to one embodiment of the present disclosure will be described with reference to FIG. 1 that is a schematic view.

The AI message generation control system in the vehicle may include at least one of a cognitive load determination unit 11, an AI message generation unit 12, a database 13, and a generative AI model 14.

The cognitive load determination unit 11 may perform all operations for determining a driver's cognitive load level of a vehicle. All operations for determining the cognitive load level may include an operation of acquiring information related to the vehicle (e.g., a driving speed of the vehicle, the driver's driving experience, the driver's accident history, the driving time of the vehicle, the number of passengers of the vehicle, weather information of a driving location, and a visible distance), and an operation of measuring the amount of conversation between passengers of the vehicle and adjusting the cognitive load level.

The driver's cognitive load level may mean an index quantitatively indicating a relative relation between information capacity that the driver can process while driving and information capacity to be processed. The cognitive load level may refer to an index that comprehensively evaluates a ratio of the information capacity to be processed to the information capacity that the driver can process or the cognitive burden caused by the ratio. For example, when a driving speed of the vehicle is slow, the driver's driving skill (e.g., a long driving experience or a low accident history) is high, the number of passengers is small, and a visible distance is long, it may be regarded that the cognitive load level is low. On the contrary, when the driving speed of the vehicle is fast, the driver's driving skill (e.g., a short driving experience or a high accident history) is low, the number of passengers is large, and the visible distance is short due to weather conditions, it may be regarded that the cognitive load level is high.

The AI message generation unit 12 may perform all operations for generating an AI message transmitted to the driver. In this case, all operations for generating AI message may include an operation of determining an AI message generation manner that matches a corresponding level depending on the cognitive load level, an operation of determining a preset AI message generation manner as the AI message generation manner when the cognitive load level has not reached a threshold value, an operation of generating a prompt for AI message generation by using the determined AI message generation manner, an operation of determining the number of sentences constituting the AI message, an operation of determining a length of a sentence constituting the AI message, an operation of determining an output size (e.g., voice size, and text size) and an output speed when the AI message is output as a voice or display, an operation of determining a waiting time to receive a response from the driver after outputting the AI message, and an operation of determining the waiting time to receive a message from the driver to generate the AI message.

The database 13 may store information necessary for operations performed by the vehicle AI message generation system 10 of the present disclosure. For example, the database 13 may include vehicle-related information (e.g., the driving speed of the vehicle, the driver's driving experience, the driver's accident history, the driving time of the vehicle, the number of passengers of the vehicle, weather information of a driving location, and visible distance), and information on the AI message generation manner (e.g., a message generation manner of a cognitive load level 1, a message generation manner of a cognitive load level 2, a message generation manner of a cognitive load level 3, a preset message generation manner, and a threshold value of the cognitive load level).

The generative AI model 14 may mean an AI model for generating an AI message. The generative AI model 14 may generate a message to be transmitted to the driver by receiving the prompt. The generative AI model 14 may be embedded in the AI message generation control system of the vehicle according to the present disclosure in the form of an on-device. In addition, the generative AI model 14 may receive the prompt and transmit the generated AI message through communication with the AI message generation control system of the vehicle of the present disclosure outside the AI message generation control system of the vehicle of the present disclosure.

It should be noted that the operation of each component of the AI message generation control system (hereinafter, referred to as a vehicle AI control system) in the vehicle is not limited to the above example, but may include an operation related to an AI message generation control method (hereinafter, referred to as a vehicle AI control method) in the vehicle according to some embodiments of the present disclosure, which will be described below. In addition, the technical spirits that may be grasped through some embodiments of the present disclosure, which will be described below, may be applied to the vehicle AI message generation control system described above even though there is no separate description.

In addition, the vehicle AI control method according to some embodiments of the present disclosure may be performed by one or more computing devices. For example, the vehicle AI control method may be generated by two or more computing devices. Some methods included in the vehicle AI control method may be performed by a first computing device, and the other methods included in the vehicle AI control method may be performed by a second computing device.

The computing device may be a computing device provided in a vehicle in which the vehicle AI control system described with reference to FIG. 1 may be driven or a computing device separate from the vehicle. In the following description, the subject of a specific step/operation may be omitted, and in this case, it may be understood that the step/operation is performed by the computing device.

The components of the vehicle AI control system according to one embodiment of the present disclosure have been described as above with reference to FIG. 1. Hereinafter, the vehicle AI control method according to some embodiments of the present disclosure will be described with reference to FIGS. 2 to 26.

The vehicle AI control method according to one embodiment of the present disclosure will be described with reference to FIG. 2. First, generation of an AI message related to a vehicle may be determined during a driving process of the vehicle (S10).

The AI message related to the vehicle may refer to all types of communication contents generated and delivered by the artificial intelligence (AI) system in the vehicle to provide information on interactions with the driver or driving conditions.

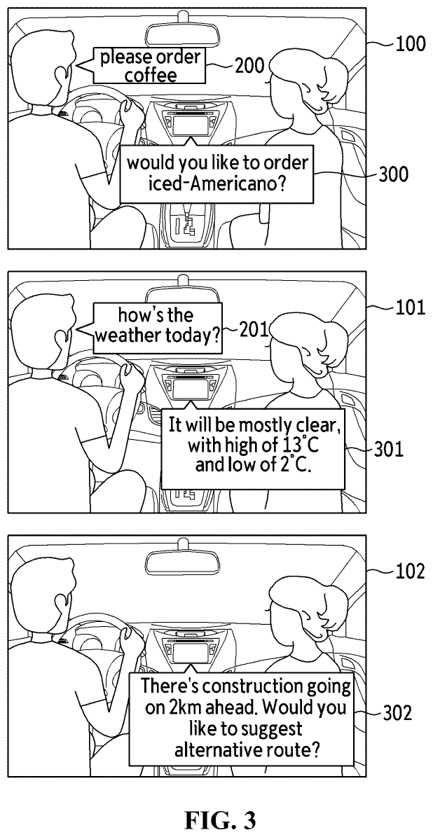

For example, as in the example 100 of FIG. 3, an AI message 300 related to the vehicle may be a message for confirmation of the driver's instruction 200 and an additional question. For another example, as in the example 101 of FIG. 3, an AI message 301 related to the vehicle may be a message for an answer to the driver's question 201. For another example, as in the example 102 of FIG. 3, an AI message 302 related to the vehicle may be a message for providing the driver with information (e.g., a route that may replace a route under construction) or warning (e.g., warning about lane departure) or suggestion (e.g., recommending a route for a frequently visited building) in accordance with specific conditions (e.g., occurrence of traffic accident, construction progress on a route, lane departure, and arrival near a frequently visited building).

Hereinafter, the drawing as in the example 100 of FIG. 3 is an exemplary view illustrating a scene in which a driver, a passenger, and artificial intelligence interact with one another in a vehicle.

It should be noted that determining generation of AI message related to the vehicle does not mean that the vehicle-related AI message is immediately generated. After the generation of the vehicle-related AI message is determined, the driver's cognitive load level of the vehicle may be determined, and the vehicle-related AI message may be generated in consideration of the cognitive load level.

Referring back to FIG. 2, after the generation of the vehicle-related AI message is determined, the driver's cognitive load level of the vehicle may be determined using the vehicle-related information (S20).

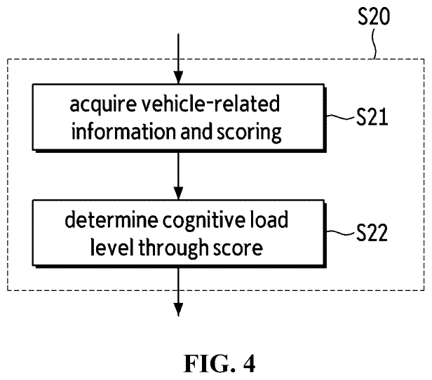

In detail, as shown in FIG. 4, in determining the driver's cognitive load level of the vehicle by using the vehicle-related information, the vehicle-related information is acquired, cognitive load scoring is performed in accordance with the acquired information (S21), and the cognitive load level may be determined using the cognitive load score (S22).

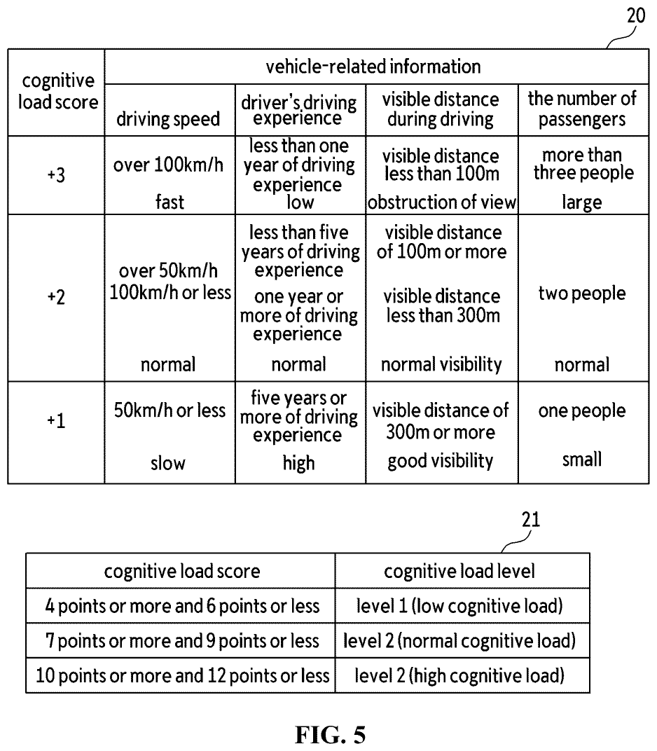

For example, as shown in Table 20 of FIG. 5, a cognitive load score to be scored may be determined in advance in accordance with the vehicle-related information. For example, when the driving speed of the vehicle exceeds 100 km/h, the driver's driving experience is less than one year, the visible distance is less than 100 m during driving, or the number of vehicle passengers is three or more, the cognitive load score may be determined as 3 points. In addition, when the driving speed of the vehicle exceeds 50 km/h and is less than or equal to 100 km/h, the driver's driving experience is greater than or equal to 1 year and less than 5 years, the visible distance is greater than or equal to 100 m and less than 300 m during driving, or the number of vehicle passengers is two, the cognitive load score may be determined as 2 points. In addition, when the driving speed of the vehicle is less than or equal to 50 km/h, the driver's driving experience is greater than or equal to 5 years, the visible distance is greater than or equal to 300 m during driving, or the number of vehicle passengers is one, the cognitive load score may be determined as 1 point.

The cognitive load score may not be determined when all conditions of the table 20 are satisfied, but be determined when one condition is satisfied. In addition, the cognitive load score may be determined and summed for each condition. For example, when the driving speed exceeds 100 km/h (+3), the driving experience is greater than or equal to 5 years (+1), the visible distance is greater than or equal to 300 m (+1), and the number of passengers is 2 (+2), the cognitive load score may be summed for each condition and determined as 7 points.

In addition, it should be noted that the cognitive load scoring according to the table 20 of FIG. 5 is for convenience of description, and is not limited to the above-described examples. Conditions (e.g., the current driving time and a type of other vehicle in close proximity to the vehicle) not shown in the table 20 may be added, and the conditions shown in the table 20 may be further subdivided (e.g., driving speed less than or equal to 50 km/h→driving speed less than or equal to 50 km/h and exceeding 30 km/h, and driving speed less than or equal to 30 km/h) or simplified (e.g., the number of passengers 2, and the number of passengers 1→the number of passengers 2 or less) by integration.

The cognitive load level may be determined depending on the cognitive load score scored and summed based on each condition. For example, as shown in Table 21 of FIG. 5, when the cognitive load score is greater than or equal to 4 points and less than or equal to 6 points, it means that the degree of the driver's cognitive load is low, and the cognitive load level may be determined as 1. In addition, when the cognitive load score is greater than or equal to 7 points and less than or equal to 9 points or less, it means that the degree of the driver's cognitive load is normal, and the cognitive load level may be determined as 2. In addition, when the cognitive load score is greater than or equal to 10 points and less than or equal to 12 points, it means that the degree of the driver's cognitive load is high, and the cognitive load level may be determined as 3.

In addition, it should be noted that the cognitive load scoring according to the table 21 of FIG. 5 is for convenience of description, and is not limited to the above-described examples. Levels (e.g., a cognitive load level 4 and a cognitive load level 5) not shown in the table 21 may be added, and the conditions shown in the table 21 may be further subdivided or simplified (e.g., high cognitive load level and low cognitive load level) by integration.

Referring back to FIG. 2, after the cognitive load level is determined, the AI message generation manner may be determined in consideration of the cognitive load level (S30). The AI message generation manner may be a manner of reducing a length of AI message as the cognitive load level increases. Subsequently, the AI message may be generated in accordance with the AI message generation manner (S40).

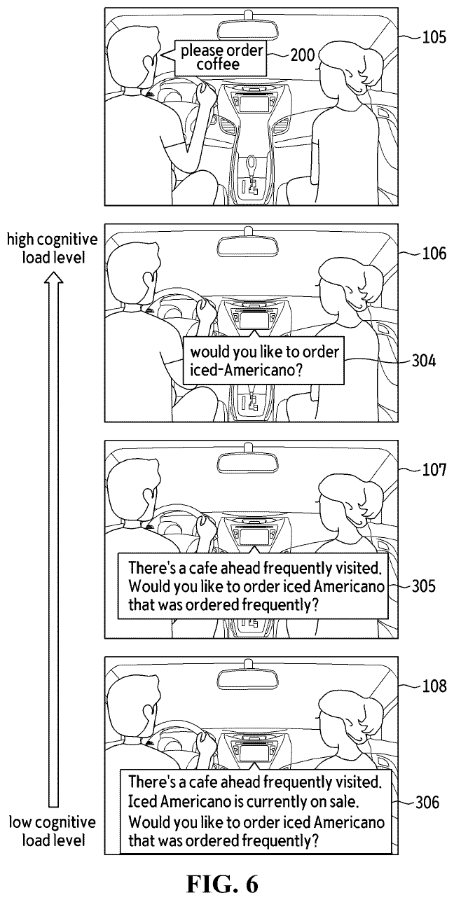

For example, as in the example 105 shown in FIG. 6, the driver may transmit an instruction 202 to order coffee to the AI system through a voice. The AI system mounted in the vehicle may generate a message by varying a length of the message depending on the driver's cognitive load level of the vehicle. In detail, as in the example 106 shown in FIG. 6, when there is a lot of information to be processed by the driver due to a high cognitive load level, the AI system may generate a short message 304 so that the driver may process the information. Also, as in the example 107 shown in FIG. 6, when the cognitive load level is average, the AI system may generate a message 305 having a normal length. Also, as in the example 108 shown in FIG. 6, when information to be processed by the driver is small due to a low cognitive load level, the AI system may generate a long message 306 to deliver a lot of information to the driver.

The length of the message may be adjusted by adjusting the number of sentences constituting the message or the length of the sentences constituting the message. For example, it may be assumed that the AI message 305 of the example 107 shown in FIG. 6 is a reference of the AI message. In detail, the AI message is composed of two sentences, and may include a keyword (e.g., an order menu) required for a response of the driver's instruction 202 and a keyword (e.g., information related to an order store and an order menu) related to the above keyword. In the case of the example 106 having a higher cognitive load level than in the example 107, the number of sentences constituting the AI message is reduced from two to one, and only a keyword (e.g., order menu) necessary for responding to the driver's instruction 202 may be included in the AI message. In the case of the example 108 having a lower cognitive load level in the example 107, the number of sentences constituting the AI message is increased from two to three, and a keyword necessary for responding to the driver's instruction 202 and a keyword (e.g., discount menu) related to the above keyword may be further included in the AI message.

That is, as the cognitive load level increases, the length of the AI message may be reduced so that the driver may process the AI message. The length of the AI message may be reduced by reducing the number of sentences or the number of keywords. In addition, as the cognitive load level decreases, the length of the AI message may be increased so that more information may be provided to the driver to improve convenience of the driver. The length of the AI message may be increased by increasing the number of sentences or the number of keywords.

It should be noted that adjusting the number of sentences constituting the message and the number of keywords in the message generation manner is for convenience of description, and the message generation manner is not limited to the above-described example. For example, the message generation manner may be determined by changing a tone (e.g., formal or informal) of the message. In detail, in order to reduce the length of the message, the tone of the AI message may be changed to informal, and in order to increase the length of the message, the tone of the AI message may be changed to formal.

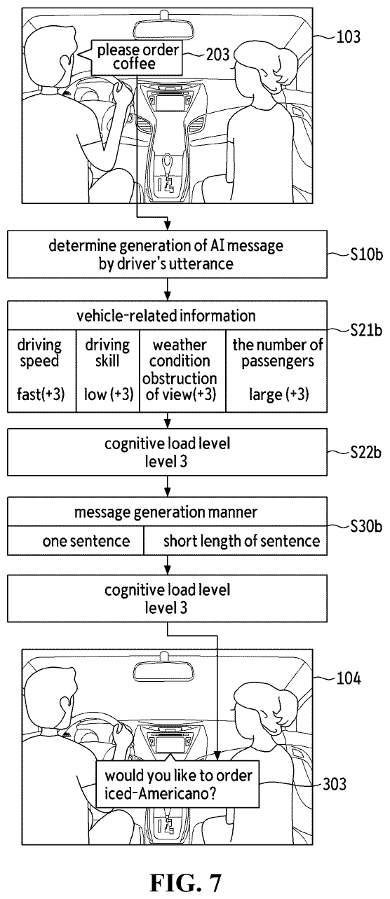

FIG. 7 is a flow chart illustrating comprehensively the above-described vehicle AI control method according to the present embodiment. First, as in the example 103 of FIG. 7, the driver may deliver an instruction 203 to order coffee to the AI system. It may be determined that an AI message in which an utterance of the driver's instruction 203 is detected is generated (S10a). Subsequently, vehicle-related information (e.g., driving speed, driving skill, weather conditions, and the number of passengers) may be acquired to determine the driver's cognitive load level (S21a). A cognitive load score (e.g., 12 points) may be determined using the acquired information, and a cognitive load level (e.g., level 3) may be determined in accordance with the cognitive load score (S22a). Since the cognitive load level is determined as level 3, which means that the cognition load level is high, a message generation manner (e.g., one generated sentence, and short generated sentence) for reducing the length of the message may be determined so that the driver may recognize the AI message (S30a). Next, an AI message (e.g., “Would you like to order an iced Americano?”) that is a response to the driver's instruction 203 may be generated in accordance with the AI message generation manner (S40a). The generated AI message 303 may be output as a voice as in the example 104 of FIG. 7.

In summary, when it is determined that the AI message is generated, the driver's cognitive load level may be determined using the vehicle-related information. Subsequently, an AI message generation manner may be determined so that the driver may recognize the AI message depending on the driver's cognitive load level, and the AI message may be generated in accordance with the determined manner. Through this embodiment, the driver may recognize the AI message even when the cognitive load level is high, and may recognize more information when the cognitive load level is low. As a result, convenience of the driver may be improved.

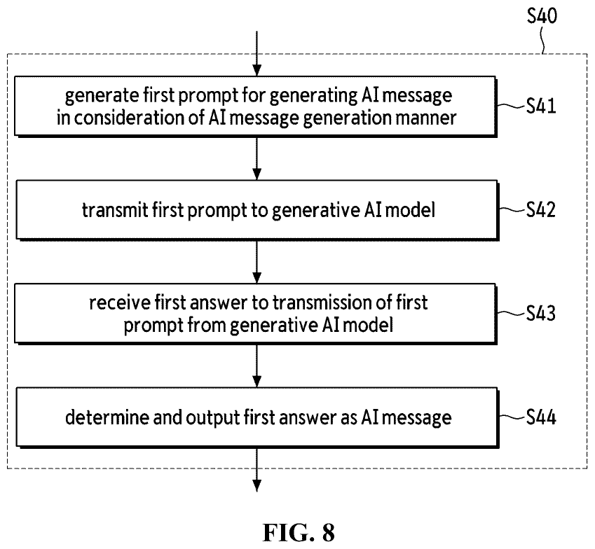

The AI of the present disclosure may be a generative AI model such as a large language model (LLM). An embodiment in which the AI of the present disclosure is a generative AI model will be described with reference to FIG. 8.

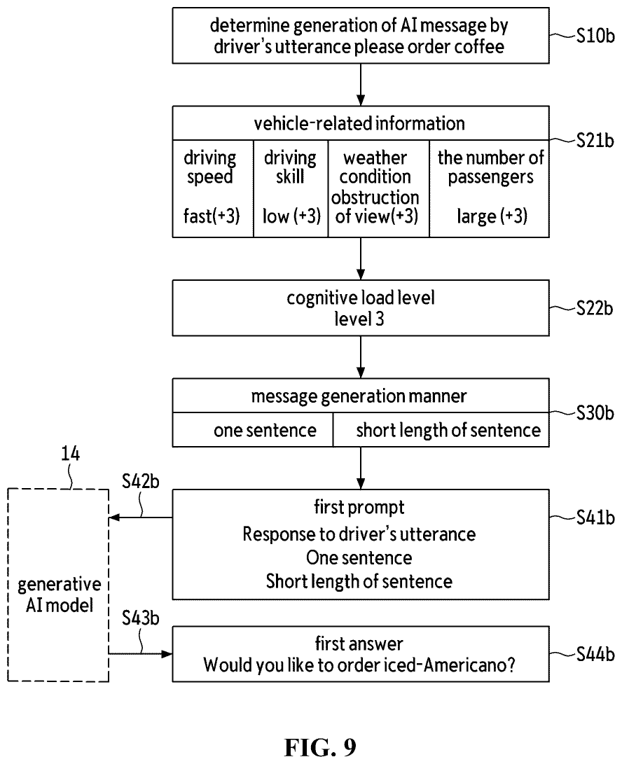

First, a first prompt for generating an AI message in consideration of the AI message generation manner may be generated (S41). For example, as shown in FIG. 9, AI message generation may be determined by the driver's utterance (S10b), and the vehicle-related information may be acquired (S21b) to determine the cognitive load level (S22b). When the message generation manner is determined depending on the cognitive load level (S30b), the first prompt in consideration of the determined message generation manner may be generated (S41b). In detail, the message generation manner may be determined in a manner that the number of sentences constituting the message is one and the length of the sentence constituting the message is short. The first prompt may be generated as follows, in consideration of the message generation manner: “Please generate a message that responds to the driver's utterance. Please make one sentence constituting the message and make the length of the sentence short.”

Referring back to FIG. 8, the generated first prompt may be transmitted to the generative AI model (S42). Subsequently, a first answer in response to the transmission of the first prompt may be received from the generative AI model (S43). The received first answer may be determined as an AI message and transmitted to the driver (S44).

For example, as shown in FIG. 9, the first prompt may be transmitted to the generative AI model 14 (S42b). Subsequently, the first answer may be received from the generative AI model 14 in response to the transmission of the first prompt (S43b). The received first answer (e.g., Would you like to order an iced Americano?) may be determined as the AI message, and may be output as a voice through a device provided in the vehicle.

It should be noted that reflection of the AI message generation manner in the first prompt is not limited to the above-described example. For example, the first prompt may include not only the AI message generation manner but also the vehicle-related information for determining the AI message generation manner. In addition, for understanding of the context of AI message generation, information related to the vehicle which is currently driving may be included in the first prompt.

In summary, when the AI message generation manner is determined, a prompt for generating an AI message may be generated by reflecting the determined AI message generation manner. The generated prompt may be transmitted to the generative AI model, and an answer that responds to transmission of the prompt may be received from the generative AI model, whereby the AI message may be generated. In the present embodiment, the time and cost of generating the AI message may be reduced using the generative AI model, and a message suitable for the context of a situation requiring the AI message may be generated.

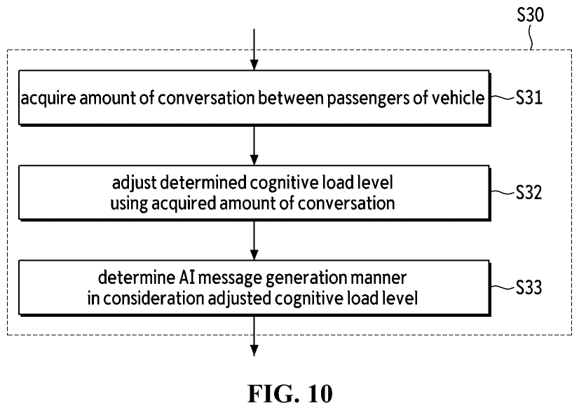

The cognitive load level determined in some embodiments of the present disclosure as described above may be adjusted through conversations between passengers of the vehicle. When the cognitive load level is determined to be low but the amount of conversation between passengers of the vehicle is measured to be less than a threshold value, since it may mean that the degree of the driver's cognitive load is high, the cognitive load level may be adjusted to increase. On the contrary, when the cognitive load level is determined to be high but the amount of conversation between passengers of the vehicle is measured to be greater than or equal to a threshold value, since it may mean that the degree of the driver's cognitive load is low, the cognitive load level may be adjusted to decrease. Hereinafter, an embodiment in which a cognitive load level is adjusted using conversation between passengers of a vehicle will be described with reference to FIGS. 10 to 14.

First, the amount of conversation between the passengers of the vehicle may be acquired (S31). The conversation between the passengers of the vehicle may be a conversation measured before the AI message generation is determined. In addition, the conversation between the passengers of the vehicle may mean a conversation between the driver and the passenger of another vehicle other than the driver.

Next, the cognitive load level determined using the acquired amount of conversation may be adjusted (S31). For example, since the greater amount of conversation between the driver and the other passenger may mean that the degree of the driver's cognitive load is low, the cognitive load level may be adjusted to be lower. On the contrary, since the smaller amount of conversation between the driver and the other passenger may mean that the degree of the driver's cognitive load is high, the cognitive load level may be adjusted to be higher.

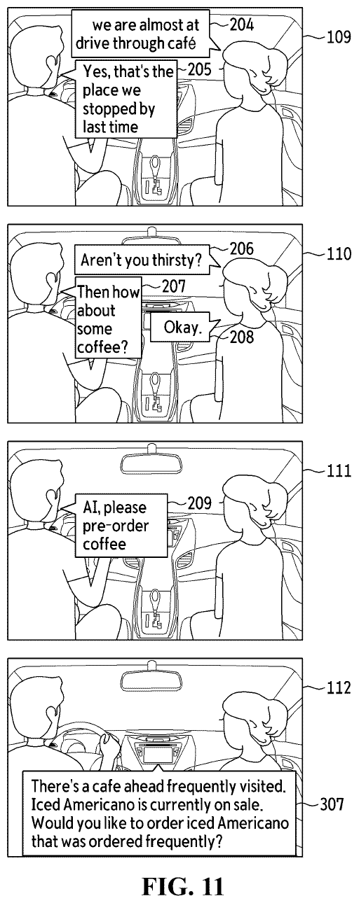

For example, as shown in FIG. 11, the driver and the other passenger may have a conversation. As shown in the examples 109 and 110 of FIG. 11, the driver and the other passenger may utter 204, 205, 206, 207 and 208 five times for conversation, and the number of utterances (e.g., five times) of the passenger or the time (e.g., 30 seconds) during which the conversation took place may be measured. Also, as in the example 111 of FIG. 11, the driver may transmit a message (e.g., AI, pre-order coffee) to instruct 209 to the AI.

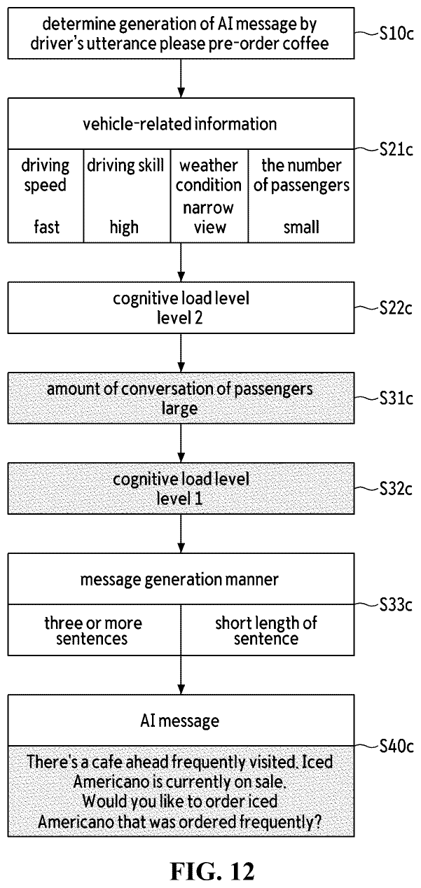

Subsequently, as shown in FIG. 12, whether to generate an AI message may be determined by the driver's instruction to the AI (S10c). Subsequently, the vehicle-related information is acquired (S21c), and the cognitive load level (e.g., level 2) may be determined using the acquired information (S22c). Subsequently, according to the present embodiment, as the number of utterances of the passenger or the time during which conversations are made between the passengers exceeds a threshold value, it may be determined that the amount of conversation of the passengers is large (S31c). Accordingly, since it may mean that the degree of the driver's cognitive load is low, the cognitive load level may be adjusted to be lower (e.g., level 2→level 1) (S32c).

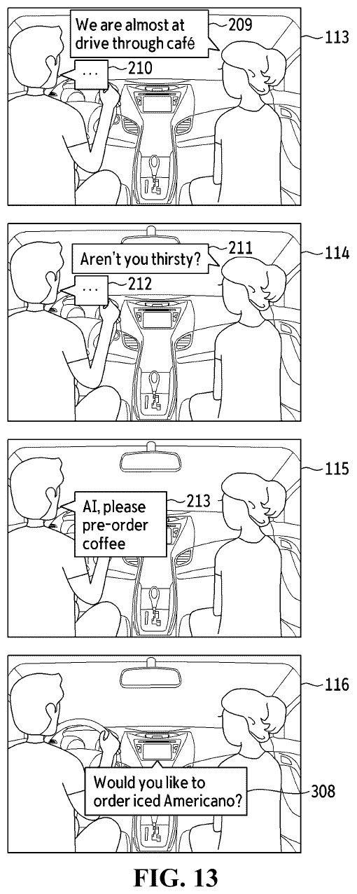

On the contrary, as in examples 113 and 114 of FIG. 13, the driver does not utter 210 and 212 while concentrating on driving, but only other passengers may utter 209 and 211. Also, the number of utterances (e.g., two times) of the passengers or the time (e.g., 10 seconds) during which the conversation took place may be measured. Also, as in the example 115 of FIG. 13, the driver may deliver a message (e.g., AI, pre-order coffee) to instruct 213 to the AI.

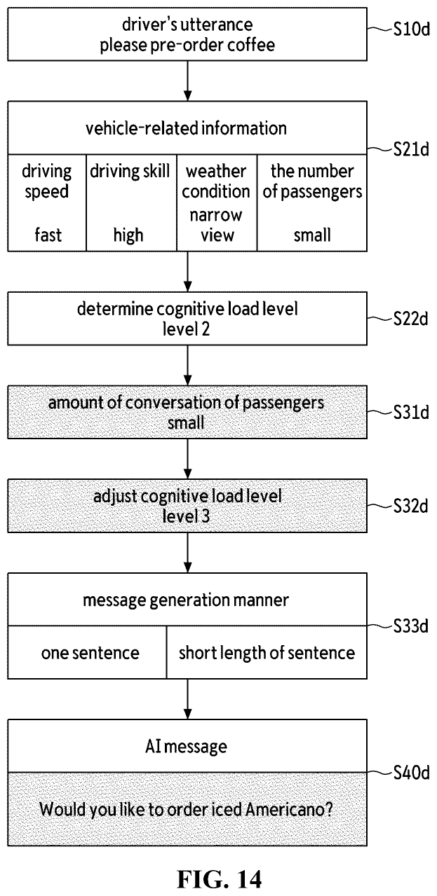

Subsequently, as shown in FIG. 14, whether to generate an AI message may be determined by the instruction of the driver to the AI (S10d). Subsequently, the vehicle-related information is acquired (S21d), and the cognitive load level (e.g., level 2) may be determined using the acquired information (S22d). Subsequently, according to the present embodiment, as the number of utterances of the passengers or the time during which the conversations are made between the passengers is less than a threshold value, it may be determined that the amount of conversation of the passengers is small (S31d). Accordingly, since it may mean that the degree of the driver's cognitive load is high, the cognitive load level may be adjusted to be higher (e.g., level 2→level 3) (S32d).

Referring back to FIG. 10, the AI message generation manner may be determined in consideration of the adjusted cognitive load level (S33). Subsequently, as in some other embodiments, the AI message may be generated in accordance with the determined AI message generation manner.

For example, as in the example 112 of FIG. 11, a generation manner is determined so that the length of the AI message increases, in consideration of the adjusted cognitive load level (e.g., level 1), and an AI message 307 may be generated and output in accordance with the determined generation manner. In detail, as shown in FIG. 12, a message generation manner may be determined based on the adjusted cognitive load level (e.g., level 1) (S32c). Subsequently, in consideration of the determined message generation manner, an AI message (e.g., there is a cafe ahead frequently visited. Iced Americano is currently on sale. Would you like to order the iced Americano that was ordered frequently?) may be generated so that the number of sentences is three or more and the length of the sentence becomes longer (S40c).

On the contrary, as in the example 116 of FIG. 13, a generation manner is determined to reduce the length of the AI message in consideration of the adjusted cognitive load level (e.g., level 3), and an AI message 309 may be generated and output in accordance with the determined generation manner. In detail, as shown in FIG. 14, a message generation manner may be determined based on the adjusted cognitive load level (e.g., level 3) (S32d). Subsequently, in consideration of the determined message generation manner, an AI message (e.g., Would you like to order an iced Americano?) may be generated so that the number of sentences is one and the length of the sentence becomes shorter (S40d).

The embodiment in which the cognitive load level is adjusted through the amount of conversation between passengers has been described as above with reference to FIGS. 10 to 14. Determining the cognitive load level in consideration of the amount of conversation between passengers as well as vehicle-related information may accurately measure the driver's cognitive load level rather than determining the cognitive load level by using only vehicle-related information. In conclusion, in the present embodiment, the length of the AI message may be more appropriately adjusted, so that an effect that the driver may sufficiently recognize the AI message may be expected.

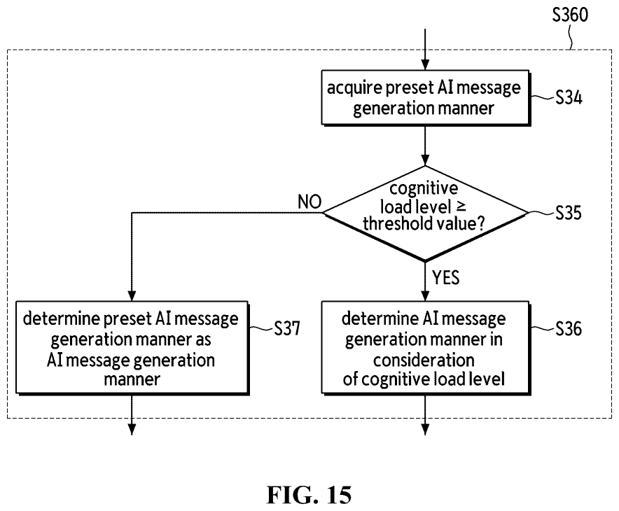

When the AI message generation manner is frequently changed depending on the cognitive load level, the driver may feel tired of the AI message. Therefore, it may be necessary to apply a certain AI message generation manner regardless of determining the cognitive load level. However, when it is detected that the degree of the driver's cognitive load is clearly high, it may be effective to deliver the AI message of a short-length to the driver without considering the driver's fatigue for the AI message. Therefore, an embodiment in which the AI message generation manner is determined differently only when the cognitive load level is greater than or equal to a threshold value will be described with reference to FIGS. 15 to 17.

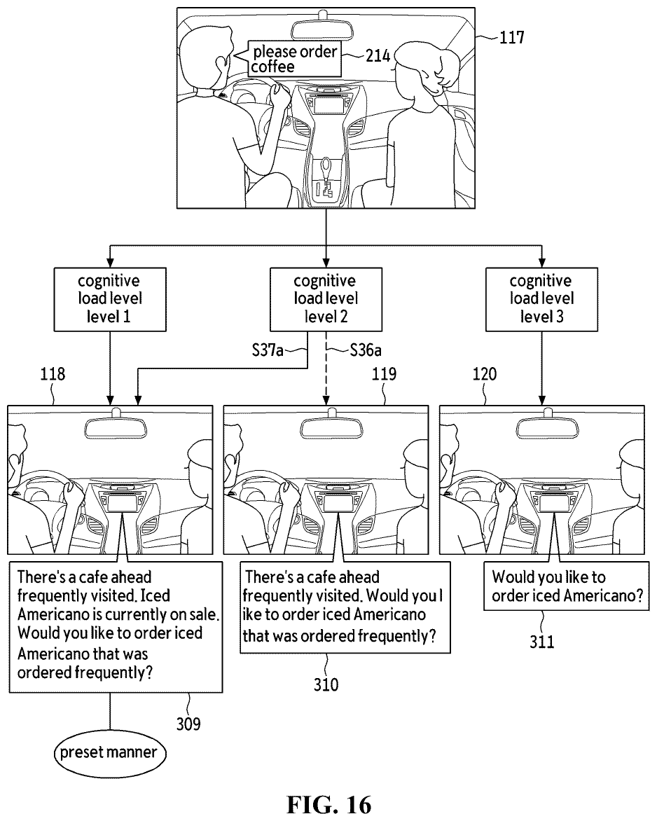

As shown in FIG. 15, after the driver's cognitive load level is determined, a preset AI message generation manner may be acquired (S34). For example, as in the AI message 309 in the example 118 of FIG. 16, an AI message generation manner may be set in advance so that the length of the AI message becomes longer. In detail, the driver may select an AI message generation manner so that the number of sentences constituting the AI message is three or more and the length of each sentence becomes longer by hoping a detailed AI message. In this case, after the driver's cognitive load level is determined, a message generation manner that increases the length of the message may be acquired as a preset AI message generation manner.

Next, it may be determined whether the cognitive load level is greater than or equal to a threshold value (S35). In this case, when the cognitive load level is greater than or equal to a threshold value, since the degree of the driver's cognitive load is clearly high, an AI message generation manner may be determined in consideration of the cognitive load level (S36). On the contrary, when the cognitive load level is less than the threshold value, since the degree of the driver's cognitive load is not high, an AI message generation manner may be determined in a preset AI message generation manner regardless of the cognitive load level (S37).

For example, as in the example 117 of FIG. 16, an instruction 214 of the driver to order coffee may be transmitted to the AI by voice. It may be assumed that the AI message generation manner is set to generate an AI message like the AI message 309 of the example 118. In addition, it may be assumed that the threshold value of the cognitive load level is set to level 3. In this assumption, when the driver's cognitive load level is level 1 or level 2, an AI message having a large number of sentences and a long sentence may be generated, like the AI message 309 of the example 118.

In particular, when there is no preset manner, and when the driver's cognitive load level is level 2, a message may be generated so that the number of sentences becomes two and the length of the sentence becomes normal, like an AI message 310 of the example 119. On the other hand, when there is a preset manner, even though the driver's cognitive load level is level 2, a message may be generated so that the number of sentences becomes three and the length of the sentence becomes longer, like the message 309 of the example 118.

As another example, when the driver's cognitive load level is level 3 and the threshold value of the cognitive load level is level 3, an AI message having a small number of sentences and a short length of sentences, such as an AI message 311 of the example 120, may be generated. When the threshold value of the cognitive load level is not level 3, even though the driver's cognitive load level is level 3, an AI message may be generated in accordance with the preset AI message generation manner like the AI message 309 of the example 118.

In summary, the threshold value may mean a cognitive load level when the degree of cognitive load is so high that the AI message generated in a preset manner cannot be recognized. When the driver's cognitive load level is greater than or equal to the threshold value, regardless of the preset AI message generation manner, an AI message generation manner may be determined depending on the cognitive load level, so that an AI message may be generated. Through this embodiment, the driver may receive an AI message adjusted depending on the cognitive load level only when necessary without feeling tired of the AI message.

The threshold value of the cognitive load level may be arbitrarily set by the user or automatically determined in accordance with the preset AI message generation manner.

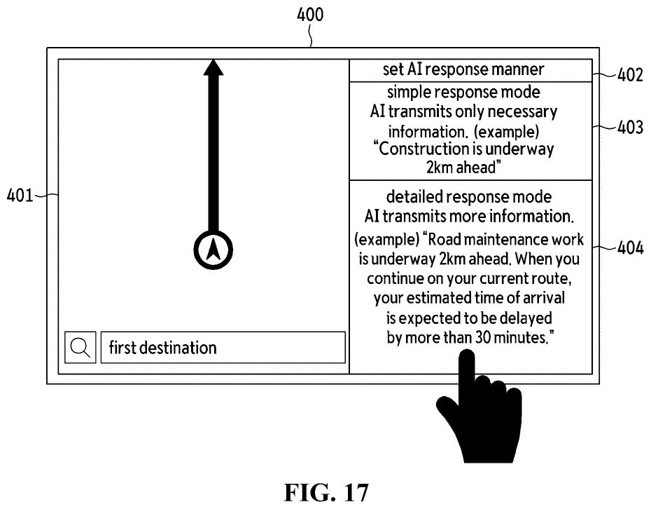

The preset AI message generation manner may be an AI message generation manner set in advance by the driver. For example, as shown in FIG. 17, a screen 402 capable of setting an AI message generation manner may be displayed together with a navigation 401 through a display 400 provided in the vehicle. A user (e.g., a driver) of the display 400 may select one of “Simple Response Mode 403,” which is a manner of generating an AI message so that the number of sentences constituting the AI message is small and the length of each sentence becomes shorter, and “Detailed Response Mode 404” which is a manner of generating an AI message so that the number of sentences constituting the AI message is large and the length of each sentence becomes longer.

In detail, when the user selects the “detailed response mode 404”, as long as the driver's cognitive load level does not exceed the threshold value (e.g., cognitive load level 3), the AI message may be generated so that the number of sentences constituting the AI message is large and the length of each sentence becomes longer. On the contrary, when the user selects the “simple response mode 403”, regardless of the threshold value, the AI message may be generated so that the number of sentences constituting the AI message is small and the length of each sentence becomes shorter.

In summary, the AI message generation manner may be set by the user (e.g., the driver), and the length of the message may be adjusted in accordance with the user's selection. It should be noted that the AI message generation manner set in accordance with the user's selection is not limited to the above-described example. For example, the user may determine the time (e.g., weekday, weekend, commute time, and quitting time) when the AI message is generated and a place (e.g., general road, and highway) where the AI message is generated, in a mode set by himself or herself.

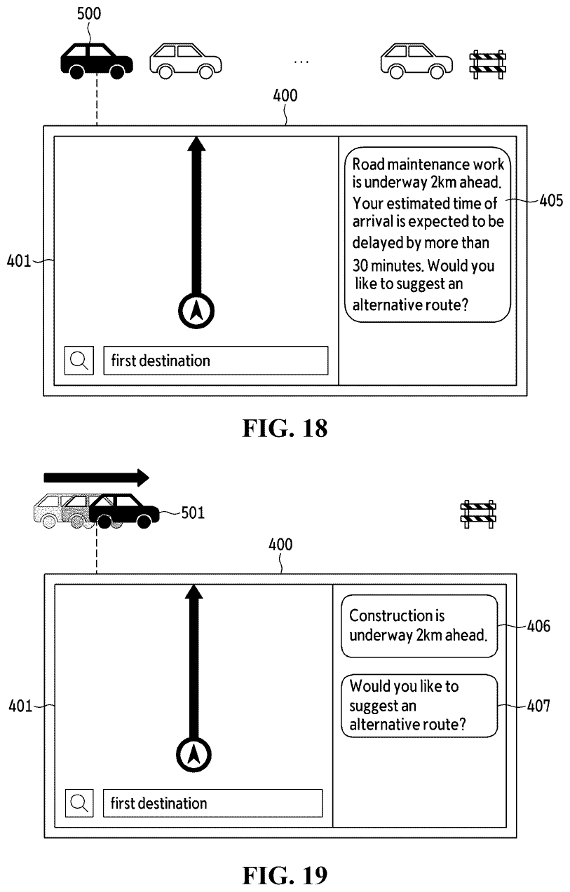

The output of the AI message has been described as a voice output by way of example. The AI message may be displayed and output on a display provided in the vehicle. Hereinafter, an embodiment in which an AI message is displayed on a display will be described with reference to FIGS. 18 to 19.

In one embodiment, after a cognitive load level is determined, an AI message generation manner is determined in consideration of the cognitive load level, and an AI message is generated in accordance with the determined AI message generation manner, the AI message may be displayed as text.

For example, as shown in FIG. 18, the generated AI message may be displayed as a text 405 on the display 400 including the screen 401 for guiding the route of the vehicle. As a detailed example, when it is confirmed that the construction is in progress on a driving route of a vehicle 500, a message indicating that the construction is in progress, indicating that an estimated time of arrival may be delayed and suggesting an alternative route may be generated and displayed as the text 405.

A method of displaying the generated AI message may be changed depending on the driver's cognitive load level of the vehicle. For example, as the driver's cognitive load level increases, a text size of the AI message may increase and the number of displayed AI messages may decrease so that the driver may recognize the message. On the contrary, as the driver's cognitive load level decreases, in order to deliver a lot of information to the driver, the text size of the AI message may decrease and the number of displayed AI messages may increase.

For a detailed example, the text 405 displayed on display 400 of FIG. 18 may be text displayed when the driver's cognitive load level is low. In this case, when a moving speed of the vehicle 500 is very low due to traffic jam of the driver's vehicle 500, since the driver may recognize a message including sufficiently much information, the driver's cognitive load level may be determined to be low.

On the contrary, texts 406 and 407 displayed on the display 400 of FIG. 19 may be texts displayed when the driver's cognitive load level is high. In this case, when a moving speed of a vehicle 501 is very fast due to no traffic jam of the driver's vehicle 501, since the driver cannot recognize a message including sufficiently much information, the driver's cognitive load level may be determined to be high.

The texts 405, 406 and 407 of FIGS. 18 and 19 are compared with one another. In this case, when the cognitive load level is low, the text with a small size and more sentences may be displayed. On the contrary, when the cognitive load level is high, the text with a large size and fewer sentences may be displayed. That is, the size of the text representing the message or the length of the message may be adjusted so that the driver may recognize it, and may be displayed on the displays mounted in the vehicles 500 and 501.

Even when the generated AI message is output as a voice, an output manner may be adjusted in accordance with the driver's cognitive load level.

In one embodiment, after a cognitive load level is determined, an AI message generation manner is determined in consideration of the cognitive load level and an AI message is generated in accordance with the determined AI message generation manner, the AI message may be output as a voice. Hereinafter, the AI message output as a voice will be abbreviated as an AI voice message.

The output size of the AI voice message may be changed depending on the cognitive load level. For example, when the driver's cognitive load level is high, the size at which the AI voice message is output may increase so that the driver may recognize the message. On the contrary, when the driver's cognitive load level is low, since the driver may recognize even a small sound, the size at which the AI voice message is output may not be increased.

Also, the output speed of the AI voice message may be changed depending on the cognitive load level. For example, when the driver's cognitive load level is high, the output speed of the AI voice message may be reduced so that the driver may recognize the message. On the contrary, when the driver's cognitive load level is low, since the driver may also recognize a high-speed voice, the speed at which the AI voice message is output may not be increased.

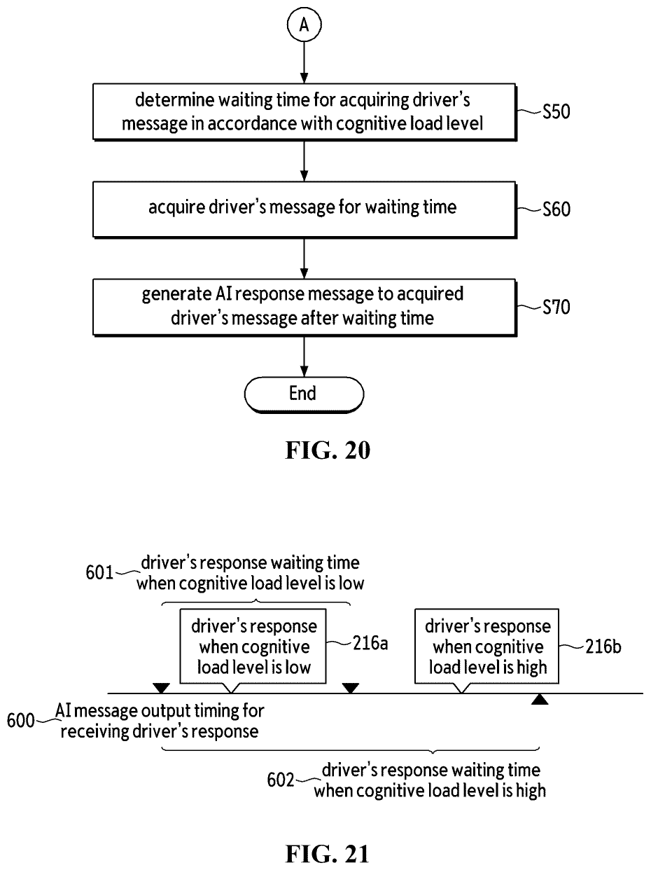

The vehicle AI control method according to some embodiments of the present disclosure has been described as above with reference to FIGS. 2 to 20. The above-described examples relate to some embodiments of the present disclosure in which the driver utters and the AI responds, or the AI utters under specific conditions. The driver may ask additional instructions or questions about the AI utterance or response. Hereinafter, an embodiment in which the time waiting for the driver's response to the AI message is adjusted depending on the cognitive load level will be described with reference to FIGS. 20 to 22.

First, as shown in FIG. 20, after the AI message is generated in accordance with the method shown in FIG. 2, the waiting time for acquiring the driver's message may be determined depending on the cognitive load level (S50).

As the driver's cognitive load level increases, the time required for the driver to recognize and respond to the AI message may be increased. Since a high level of the driver's cognitive load means a lot of information to be processed by the driver, the driver may utter a response to the AI message after processing all other information. Therefore, as the cognitive load level increases, the waiting time for acquiring the driver's message for the AI message may be determined to be increased.

For a detailed example, as shown in FIG. 21, the driver's response may be acquired within a certain time from an AI message output time point 600 for receiving the driver's response. In this case, when the cognitive load level is low, the driver immediately responds 216a to the AI message, whereas when the cognitive load level is high, the driver responds 216b to the AI message after more time than when the cognitive load level is low.

Therefore, the driver's response waiting time 602 when the cognitive load level is high may be more increased than the driver's response waiting time 601 when the cognitive load level is low. In this case, adjusting the response waiting time depending on the cognitive load level is to prevent the problem of not acquiring the driver's response 216b by applying the driver's response waiting time 601 when the cognitive load level is low even when the cognitive load level is high.

Referring back to FIG. 20, the driver's message may be acquired for the determined waiting time (S60). In this case, the driver's message may mean the driver's utterance or text directly input by the driver. Subsequently, after the waiting time, an AI response message for the acquired message of the driver may be generated (S70).

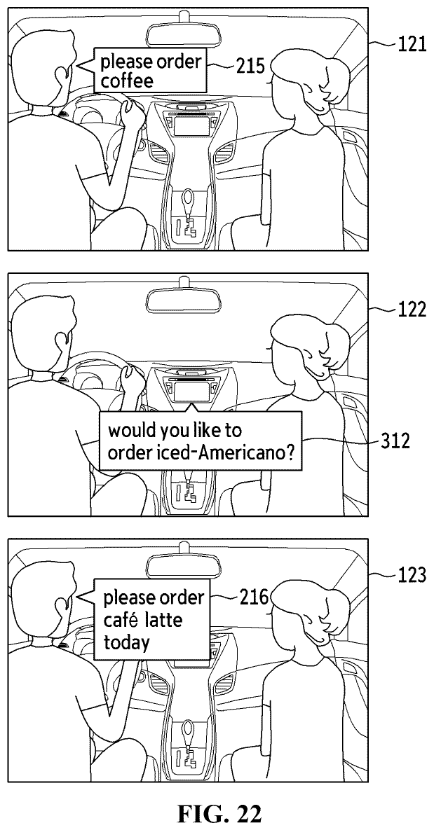

For a detailed example, as in the example 121 shown in FIG. 22, the driver may transmit an instruction 215 to order coffee to the AI through a voice. Subsequently, as in the example 122, an AI message 312 may be generated in accordance with an AI message generation manner determined in consideration of the driver's cognitive load level and output as a voice. In this case, a response message 216 to the driver's AI message 312 may be acquired for a waiting time determined depending on the cognitive load level, from the time when the AI message 312 is output as a voice. As the cognitive load level increases, the time required to acquire the driver's response message 216 may increase as in the example 123, and as the cognitive load level decreases, the time required to acquire the driver's response message 216 may decrease as in the example 123.

Controlling the time required to acquire the driver's message depending on the cognitive load level may be applied not only to acquiring a response message to an AI message from the driver, but also to acquiring an initial message from the driver.

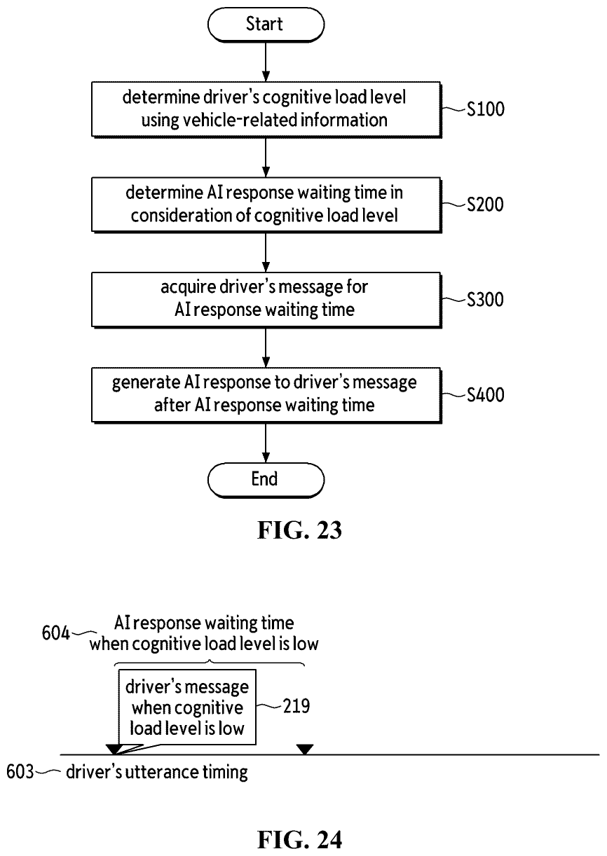

As shown in FIG. 23, first, the driver's cognitive load level of the vehicle may be determined using the vehicle-related information (S100). In this case, a manner of determining the driver's cognitive load level of the vehicle by using vehicle-related information may be the same as the aforementioned manner of determining the cognitive load level in some embodiments of the present disclosure.

Subsequently, the AI response waiting time may be determined in consideration of the determined cognitive load level (S200). For example, when the cognitive load level is level 1, the AI response waiting time is determined to be 3 seconds, when the cognitive load level is level 2, the AI response waiting time is determined to be 5 seconds, and when the cognitive load level is level 3, the AI response waiting time may be determined to be 7 seconds.

Subsequently, the driver's message may be acquired for the determined AI response waiting time (S300). For example, as shown in FIG. 24, a case in which the driver's cognitive load level is low may be assumed. Since the driver's cognitive load level is low, an AI response waiting time 604 may be determined to be short. Since the driver's cognitive load level is low, the driver may transmit the message 219 to the AI faster than when the cognitive load level is high. Accordingly, the time for the driver to utter the message is included in the AI response waiting time 604, so that the driver's message may be acquired enough to generate a response message to the driver's message

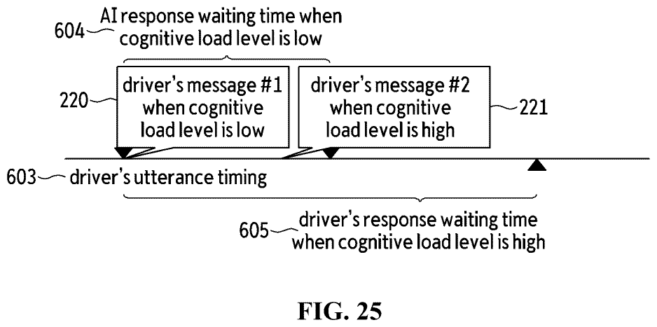

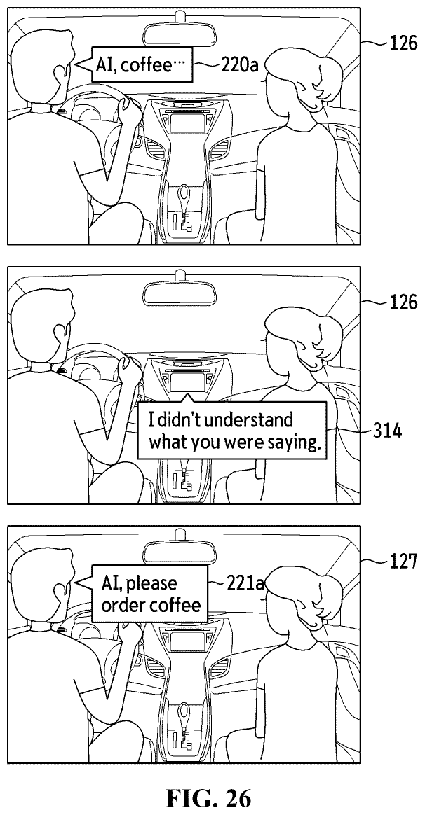

For another example, as shown in FIG. 25, a case in which the driver's cognitive load level is high may be assumed. In this case, since the cognitive load level is high, the driver may not utter all messages at once. In detail, as in the example 126 of FIG. 26, in order to solve problems (e.g., lane change, and vehicle deceleration) during the driver's utterance, the driver's utterance may be stopped. When the AI response waiting time is short as in the case that the cognitive load level is low, as in the example 126 of FIG. 26, the driver's complete message may not be acquired, and an AI message 314 that does not match the driver's intention (e.g., response to a coffee order) may be generated. Therefore, the driver should utter the complete message once again to acquire an AI message that matches the driver's intention.

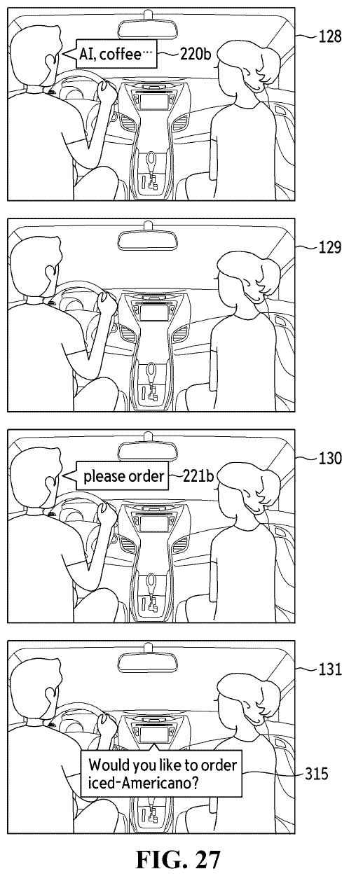

On the other hand, as shown in FIG. 25, when an AI response waiting time 605 is increased depending on the cognitive load level, even though the utterance is stopped due to the driver's cognitive load, a message that matches the driver's intention may be generated. In detail, as shown in the example 128 of FIG. 27, the driver's utterance 220b may be stopped. In this case, when the AI response waiting time increases, as in the example 129, an AI response message for the stopped utterance may not be generated. Subsequently, as in the example 130 of FIG. 27, the driver may utter 221b subsequently to a first utterance 220b. Subsequently, as in the example 131 of FIG. 27, since both messages 220b and 221b are acquired within the AI response waiting time, an AI response message 315 may be generated by combining the two messages.

In summary, in the present embodiment, the time required to acquire the driver's message may be determined depending on the driver's cognitive load level, so that the AI message may be generated even when the driver's utterance is stopped in the middle due to the driver's high cognitive load. As a result, the driver may successfully deliver the message to the AI even when the cognitive load is high.

Although the AI of the present disclosure has been described as an artificial intelligence system mounted in a vehicle in the above description, it should be noted that this is for convenience of description, and the AI of the present disclosure is not limited to that mounted in the vehicle. For example, the AI of the present disclosure is an AI system mounted in a device (e.g., server) separate from the vehicle, and only the output of the AI message may be performed through a device (e.g., speaker or display) mounted in the vehicle.

Some embodiments of the vehicle AI control system and the vehicle AI control method have been described as above with reference to FIGS. 1 to 27. According to some embodiments of the present disclosure, the length of the AI message may be adjusted depending on the driver's cognitive load so that complexity of processing information during driving may be reduced. A short and concise message may allow the driver to quickly understand key information, thereby reducing the need for complex judgment or thinking. This method may be particularly effective in an environment where the driving situation is complex or may be distracted. Unnecessary information is filtered out, and the driver may grasp only the key information, thereby focusing better on the road situation. As a result, some embodiments of the present disclosure may contribute to reducing the possibility of a traffic accident and increasing the safety of driving.

Furthermore, according to some embodiments of the present disclosure, the length of the AI message may be adjusted depending on the driver's cognitive load, so that the cognitive fatigue felt by the driver may be reduced. When the driver drives for a long time or when too much information is provided in a complicated traffic situation, the driver may easily feel tired. However, as a concise message appropriate to the situation is provided, the driver may efficiently process necessary information, thereby reducing fatigue. As a result, the driver may save energy and drive safely, and may make sure of a relaxed cognitive state even in long-distance driving or traffic congestion situations, thereby improving the overall quality of driving experience.

In addition, according to some embodiments of the present disclosure, the length of the AI message may be adjusted depending on the driver's cognitive load, so that the quality of interaction between the driver and the AI system may be improved. In this case, situations in which the driver makes repetitive requests because the message is not effectively recognized may be avoided, and computational resources for generating AI messages may be saved. The reduction in repetitive requests of AI message generation may efficiently utilize computational resources, which can lead to improved performance such as a shortened response time for the entire AI message generation system.

The effects according to the technical spirits of the present disclosure are not limited to those mentioned above, and other effects not mentioned will be clearly understood by those skilled in the art from the content of the present disclosure.

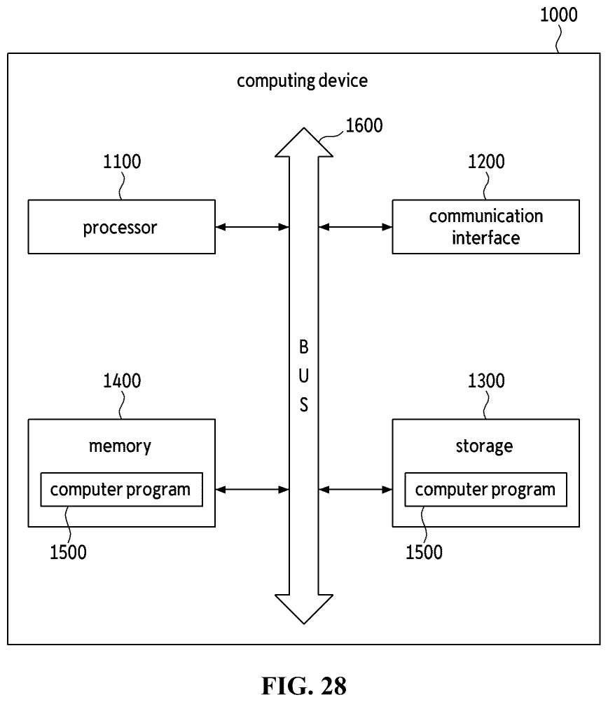

Hereinafter, a hardware configuration of an exemplary computing device according to some embodiments of the present disclosure will be described with reference to FIG. 28. The computing device may be a computing device on which the AI message generation control system of the present disclosure is driven.

FIG. 28 is a block diagram illustrating a hardware configuration in which a computing device may be implemented in various embodiments of the present disclosure. A computing device 1000 according to the present embodiment may include one or more processors 1100, a system bus 1600, a communication interface 1200, a memory 1400 for loading a computer program 1500 performed by the processor 1100, and a storage 1300 for storing the computer program 1500. In FIG. 28, only components related to embodiments of the present disclosure are shown. Accordingly, it will be apparent to those skilled in the art to which the present disclosure pertains that the computing device may further include other general-purpose components in addition to the components shown in FIG. 28.

The processor 1100 may control the overall operation of each component of the computing device 1000. The processor 1100 may include at least one of a central processing unit (CPU), a microprocessor unit (MPU), a micro controller unit (MCU), a graphic processing unit (GPU), or any type of processor well known in the technical field of the present disclosure. In addition, the processor 1100 may perform computation on at least one application or program for executing an operation/method according to various embodiments of the present disclosure. The computing device 1000 may include two or more processors.

The memory 1400 stores various types of contents, commands and/or information. The memory 400 may load one or more programs 1500 from the storage 1300 to execute the methods/operations according to various embodiments of the present disclosure. An example of the memory 1400 may be RAM, but is not limited thereto. The system bus 1600 provides a communication function between components of the computing device 1000.

The system bus 1600 may be implemented as various types of buses such as an address bus, a data bus, and a control bus. The communication interface 1200 supports wired/wireless Internet communication of the computing device 1000. The communication interface 1200 may support various communication methods other than Internet communication. To this end, the communication interface 1200 may be configured to include a communication module well known in the technical field of the present disclosure. The storage 1300 may non-temporarily store one or more computer programs 1500. The storage 1300 may include a nonvolatile memory such as a flash memory, a hard disk, a detachable disk, or any type of computer-readable recording medium well known in the art to which the present disclosure pertains.

The computer program 1500 may include one or more instructions in which methods/operations according to various embodiments of the present disclosure are implemented. When the computer program 1500 is loaded into the memory 1400, the processor 1100 may perform the methods/operations according to various embodiments of the present disclosure by executing one or more instructions.

For example, the computer program 1500 may include instructions to perform an operation of determining generation of an AI message related to a vehicle during a driving process of the vehicle, an operation of determining a driver's cognitive load level of the vehicle by using information related to the vehicle, an operation of determining a generation manner of the AI message in consideration of the determined cognitive load level, and an operation of generating the AI message in accordance with the AI message generation manner. In this case, the AI message generation manner may decrease a length of the AI message as the cognitive load level increases.

For another example, the computer program 1500 may include instructions to perform an operation of determining a driver's cognitive load level of a vehicle by using information related to the vehicle, an operation of determining an AI response waiting time to the driver's message of the vehicle in consideration of the determined cognitive load level, an operation of acquiring the driver's message of the vehicle for the response waiting time, and an operation of generating an AI response to the driver's message of the vehicle after the response waiting time.

What is claimed is:

1. A method for controlling generation of an AI message in a vehicle, which is performed by a computing device, the method comprising:
determining generation of an AI message related to a vehicle during a driving process of the vehicle;
determining a cognitive load level of a driver of the vehicle by using information related to the vehicle;
determining a generation manner of the AI message based on the cognitive load level of the driver; and
generating the AI message in accordance with the generation manner of the AI message,
wherein the generation manner of the AI message decreases a length of the AI message as the cognitive load level of the driver increases.

2. The method of claim 1, wherein a model of the AI is a generative AI model, and
the generating of the AI message includes:
generating a first prompt for generating the AI message based on the AI message generation manner;
transmitting the first prompt to the generative AI model; and
receiving a message from the generative AI model in response to the transmission of the first prompt.

3. The method of claim 1, wherein the determining of the generation manner of the AI message includes:
adjusting the cognitive load level to an adjusted cognitive level by using an amount of conversation between passengers of the vehicle; and
determining the generation manner of the AI message based on the adjusted cognitive load level.

4. The method of claim 1, wherein the determining of the generation manner of the AI message includes determining a preset generation manner of the AI message without considering the cognitive load level when the cognitive load level is less than a threshold value.

5. The method of claim 4, wherein the preset generation manner is a generation manner of the AI message set by the driver of the vehicle.

6. The method of claim 1, wherein the determining of the cognitive load level of the driver of the vehicle includes determining the cognitive load level by using a speed of the vehicle.

7. The method of claim 1, wherein the determining of the cognitive load level of the driver of the vehicle includes determining the cognitive load level by using information related to a weather condition of a location where the vehicle is at.

8. The method of claim 7, wherein the information related to the weather condition of the location includes information on a visible distance of the vehicle.

9. The method of claim 1, wherein the determining of the cognitive load level of the driver of the vehicle includes determining the cognitive load level by using information related to the driver of the vehicle.

10. The method of claim 9, wherein the information related to the driver of the vehicle includes information on a driving experience of the driver, information on an accident history of the driver, or information on a current driving duration of the driver.

11. The method of claim 1, wherein the determining of the cognitive load level of the driver includes determining the cognitive load level by using a number of passengers on the vehicle.

12. The method of claim 1, wherein the determining of the generation manner of the AI message includes determining a number of sentences constituting the AI message based on the cognitive load level of the driver.

13. The method of claim 1, wherein the determining of the generation manner of the AI message includes determining a length of a sentence constituting the AI message based on the cognitive load level.

14. The method of claim 1, further comprising outputting the AI message as a voice and determining a size of the voice based on the cognitive load level.

15. The method of claim 1, further comprising outputting the AI message as a voice and determining an output speed of the voice based on the cognitive load level.

16. The method of claim 1, further comprising displaying the AI message as a text and determining a size of the text based on the cognitive load level.

17. The method of claim 1, further comprising receiving a response of the driver of the vehicle to the AI message for a preset time,
wherein the preset time is a time determined based on the cognitive load level.

18. A method for controlling generation of an AI message in a vehicle, which is performed by a computing device, the method comprising:
determining a cognitive load level of a driver of a vehicle by using information related to the vehicle;
determining an AI response waiting time to a message of the driver of the vehicle based on the cognitive load level of the driver;
acquiring a message of the driver for the AI response waiting time; and
generating an AI response to the message of the driver of the vehicle after the AI response waiting time,
wherein the AI response waiting time is a time set to increase as the cognitive load level increases.

19. A device for controlling generation of an AI message in a vehicle, the device comprising:
a communication interface;
a memory in which a computer program is loaded; and
at least one processor in which the computer program is executed,
wherein the computer program includes a set of instructions, when executed by the at least one processor, to perform:
an operation of determining generation of an AI message related to a vehicle during a driving process of the vehicle;
an operation of determining a cognitive load level of a driver of the vehicle by using information related to the vehicle;
an operation of determining a generation manner of the AI message based on the cognitive load level of the driver; and
an operation of generating the AI message in accordance with the generation manner of the AI message,
wherein the generation manner of the AI message decreases a length of the AI message as the cognitive load level of the driver increases.
